(19) United States
(12) Patent Application Publication
(10) Pub. No.: US 2012/0034370 A1
(43) Pub. Date: Feb. 9, 2012

(54) METHOD FOR PRODUCING CHROMOPHORE AND/OR EFFECT-PRODUCING MULTILAYER VARNISHES

(75) Inventors: Patricia Kloppenborg, Steinfurt (DE); Frank Stache, Senden (DE); Egon Wegner, Greven (DE); Michael Richert, Emsdetten (DE)

(73) Assignee: BASF COATINGS AG, Munster (DE)

(21) Appl. No.: 10/595,096

(22) PCT Filed: Jul. 23, 2004
(86) PCT No.: PCT/EP2004/008226

§ 371 Date: Dec. 11, 2009

(30) Foreign Application Priority Data
Aug. 27, 2003 (DE) 10339305.6
Jun. 11, 2004 (DE) 102004028368.0

(51) Int. Cl. B05D 3/02; B05D 5/12

(52) U.S. Cl. 427/58; 427/157; 427/385.5; 427/389.7

(57) ABSTRACT

A process for producing multicoat paint systems comprising applying to substrates including unprimed substrates, substrates coated with an uncured primer or substrates coated with a cured primer, one first color and/or effect coat, one second color and/or effect coat, and one transparent coat, and jointly curing wet films of these coatings and also where appropriate the uncured primer.

### FIELD OF THE INVENTION

The present invention relates to a new process for producing multicoat color and/or effect paint systems. The present invention also relates to the multicoat color and/or effect paint systems produced by means of the new process, and to their use.

### PRIOR ART

Modern automobiles, especially top class automobiles, have multicoat color and/or effect paint systems. These systems, as is known, are made up of an electrocoat, a surfacer coat, antistonechip primer or functional coat, a color and/or effect basecoat, and a clearcoat. The multicoat paint systems are produced using what are known as wet-on-wet techniques, in which a clearcoat film is applied to a dried but uncured basecoat film and then at least basecoat film and clearcoat film are jointly cured thermally. This technique may also embrace the production of the electrocoat and of the surfacer coat, antistonechip primer or functional coat.

The multicoat color and/or effect paint systems are known to have the so-called automobile quality. According to European patent EP 0 352 298 B 1, page 15, line 42, to page 17, line 14, this means that the multicoat paint systems in question score highly for
(1) gloss,
(2) distinctiveness of image (DOI, of the reflected image),
(3) level and uniformity of hiding power,
(4) uniformity of dry film thickness,
(5) gasoline resistance,
(6) solvent resistance,
(7) acid resistance,
(8) hardness,
(9) abrasion resistance,
(10) scratch resistance,
(11) impact strength,
(12) intercoat and substrate adhesion, and
(13) weathering and UV stability.

Within these systems the surfacer coats, antistonechip primer coats or functional coats are critical to such important technological properties as impact strength and smoothness and leveling of the overall paint system. Accordingly the requirements imposed on the quality of the surfacer coats, antistonechip primer coats or functional coats are particularly stringent.

In addition, however, the technological properties of the coating materials from which these surfacer, antistonechip primer or functional coats are produced are subject to particular requirements. First of all they must provide the surfacer, antistonechip primer or functional coats in the requisite quality, with no problems and with outstanding reproducibility. They must also be preparable with simplicity and with outstanding reproducibility, however.

Not least they must also be capable of application on the line at the automaker's plant by means of modern application methods, in comparatively high wet film thicknesses, without defects, in order to give dry film thicknesses of 35 μm or more. These high dry film thicknesses, needed for the flawless technical function of the surfacer, antistonechip primer or functional coats, are a serious disadvantage, however, since they entail comparatively high raw materials costs and energy costs.

It is therefore a matter of concern within the automobile industry to lower the dry film thicknesses of the surfacer, antistonechip primer or functional coats in order to reduce the raw materials and energy costs, without this entailing any deterioration in the profile of performance properties of the multicoat paint systems, in particular a deterioration in the UV stability.

An important contribution to solving these problems has been made by the process known from German patent application DE 44 38 504 A 1. The process involves coating a substrate with an electrocoat material. The resulting electrocoat film is baked. The resulting electrocoat is coated with a first, physically or thermally curable, aqueous basecoat material. The resulting first basecoat film, without being fully cured beforehand, is coated with a second, thermally curable, aqueous basecoat material. The resulting second basecoat film, without being fully cured beforehand, is coated with a clearcoat material, to give a clearcoat film. Subsequently the first and second basecoat films and the clearcoat film are jointly baked.

The first, physically or thermally curable, aqueous basecoat material comprises as binder at least one water-dilatable polyurethane resin having an acid number of from 10 to 60 mg KOH/g and a number-average molecular weight of from 4,000 to 25,000 daltons which is preparable by reacting
at least one polyol selected from the group consisting of polyester polyols and polyether polyols having a number-average molecular weight of from 400 to 5,000, and
at least one polyisocyanate, and also, if desired,
at least one compound containing at least one isocyanate-reactive functional group and at least one (potentially) anionic group in the molecule,
at least one compound containing at least one isocyanate-reactive functional group and at least one poly(oxyalkylene) group in the molecule, and
at least one compound having a number-average molecular weight of from 60 to 600 daltons, containing hydroxyl groups and/or amino groups in the molecule,
   and neutralizing the resulting reaction product. The first basecoat material may comprise, inter alia, titanium dioxide as pigment and talc as filler. The first basecoat material produces a first basecoat or functional coat which at dry film thicknesses<35 μm, preferably <15 μm, is able to replace the conventional surfacer coats, antistonechip primer coats, or functional coats without loss of essential technological properties of the multicoat paint systems.

The known process does have the disadvantage, however, that the first basecoat material used therein does not yet have the storage stability which would be desirable for particularly economic implementation of the process. As a result it is necessary to prepare the first basecoat material not until a short time before its application, in order to obtain multicoat paint systems having very good performance properties. Furthermore, the first basecoat material constitutes, so to speak, a specialty product and therefore cannot easily be provided on the basis of the second basecoat material. In a few cases, moreover, it has been found that the UV stability of the multicoat paint systems in question is no longer fully ensured, since the known first basecoat transmits a comparatively large amount of UV radiation through to the electrocoat, leading to adhesion problems in certain circumstances. Although this problem occurs only in a few cases following long exposure to sunlight, it is nevertheless desirable to avoid this problem completely.

(Co)polymers or graft copolymers preparable by (co)polymerizing a monomer containing at least one (co)polymerizable, olefinically unsaturated group, or at least two comonomers, in the presence of at least one polyurethane selected from the group consisting of polyurethanes containing no copolymerizable, olefinically unsaturated groups and polyurethanes containing at least one lateral and/or at least one terminal copolymerizable, olefinically unsaturated group, and, if desired, partially or fully neutralizing the products are known from German patent applications DE 44 37 535 A 1, DE 199 48 004 A 1 or DE 100 39 262 A 1, from European patent applications EP 0 522 419 A 1 or EP 0 522 420 A2 or from international patent application W098/54266 A 1. These graft copolymers are used in particular as binders in aqueous basecoat materials which serve for producing color and/or effect basecoats or solid-colored topcoats of multicoat paint systems.

Normally in this context the aqueous basecoat materials are processed in a wet-on-wet technique. This may include the following steps:
(I) producing a surfacer film by applying a surfacer to the substrate,
(II) drying the surfacer film,
(III) producing a basecoat film by applying an aqueous basecoat material to the surfacer film,
(IV) drying the basecoat film,
(V) producing a clearcoat film by applying a clearcoat material to the basecoat film, and
(VI) jointly curing the surfacer film, basecoat film and clearcoat film to give the surfacer, basecoat and clearcoat
   (cf., e.g., German patent application DE 19 48 004 A 1, page 17, lines 59 to 69).

Further details of the surfacer coats, antistonechip primer coats or functional coats employed are lacking. Thus all that is stated in German patent application DE 199 48 004 A 1 on page 22, lines 18 to 20, or in German patent application DE 100 39 262 A 1 on page 20, lines 17 to 20, is that the surfacer used is the commercial aqueous surfacer Ecoprime® from BASF Coatings AG.

In general terms the storage stability of the known aqueous basecoat materials is good. Their use for preparing basecoat materials which are able to replace the conventional surfacer coats, antistonechip primer coats or functional coats in a multicoat paint system, however, is not revealed by the patent applications referred to above.

### THE OBJECT OF THE INVENTION

It is an object of the present invention to provide a new process for producing multicoat color and/or effect paint systems on substrates, comprising—atop one another in this order—
(A) at least one first color and/or effect coat,
(B) at least one second color and/or effect coat, and
(C) at least one transparent coat,
   by successively applying at least one physically or thermally curable aqueous coating material (A), at least one thermally curable aqueous coating material (B), and at least one coating material (C) to
(i) an unprimed substrate,
(ii) a substrate coated with at least one uncured or only part-cured primer (G) or
(iii) a substrate coated with at least one full-cured primer (G)
   and jointly curing
(1) the resulting wet films (A), (B), and (C), or
(2) (A), (B), and (C) and the uncured or only part-cured primer(s) (G)
   which no longer has the disadvantages of the prior art but in which, instead, the first, physically or thermally curable aqueous basecoat material (A) used has not only a relatively high storage stability but also an improved stability under shear stress, in particular a relatively high ring line stability. The first, physically or thermally curable aqueous basecoat material (A) used in the new process ought to be able to be provided with simplicity on the basis of commercially customary aqueous basecoat materials and ought to give first color and/or effect basecoats (A) which even at a thickness<15 μm are able fully to replace conventional surfacer, antistonechip primer or functional coats without detriment to the performance properties of the multicoat paint systems, in particular their stonechip protection and their UV stability even after long-term exposure. The new process ought to be able to be implemented in existing plants for applying basecoat materials by electrostatic spray application and pneumatic application, without the need for conversion work. Furthermore, in finishing plants to be erected from new, the new process ought to make it possible to dispense entirely with an installation for applying surfacers.

### The Solution According to the Invention

The present invention accordingly provides the new process for producing multicoat color and/or effect paint systems on substrates, comprising—atop one another in this order—
(A) at least one first color and/or effect coat,
(B) at least one second color and/or effect coat, and
(C) at least one transparent coat,
   by successively applying at least one physically or thermally curable aqueous coating material (A), at least one thermally curable aqueous coating material (B), and at least one coating material (C) to
(i) an unprimed substrate,
(ii) a substrate coated with at least one uncured or only part-cured primer (G) or
(iii) a substrate coated with at least one full-cured primer (G)
   and jointly curing
(1) the resulting wet films (A), (B), and (C), or
(2) (A), (B), and (C) and the uncured or only part-cured primer(s) (G),
   wherein the coating material (A) comprises
(a.1) at least one (co)polymer or graft copolymer preparable by (co)polymerizing a monomer (a 1.1) containing at least one copolymerizable, olefinically unsaturated group or at least two comonomers (a.1.1) in the presence of at least one polyurethane (a.1,2) selected from the group consisting of polyurethanes containing no copolymerizable, olefinically unsaturated groups and polyurethanes containing at least one lateral and/or at least one terminal copolymerizable, olefinically unsaturated group, and optionally carrying out partial or complete neutralization,
(a.2) at least one color and/or effect pigment,
(a.3) at least one UV-absorbing pigment, and
(a.4) talc.

The novel process for producing multicoat color and/or effect paint systems on substrates is referred to below as “process of the invention”.

### The Advantages of the Process of the Invention

In the light of the prior art it was surprising and unforeseeable for the skilled worker that the object on which the present invention was based could be achieved by means of the process of the invention. In particular it was surprising that the first physically or thermally curable aqueous basecoat material (A) used in accordance with the invention had not only a relatively high storage stability but also an improved stability under shear stress, in particular a higher ring line stability. The first physically or thermally curable aqueous basecoat material (A) used in accordance with the invention was able to be provided with simplicity on the basis of commercially customary aqueous basecoat materials and gave first color and/or effect basecoats (A) which even at a thickness<15 μm were able fully to replace conventional surfacer, antistonechip primer or functional coats without detriment to the performance properties of the multicoat paint systems, in particular to the stonechip protection and the UV stability even after long-term exposure. The process of the invention was able to be implemented in existing plants for the application of basecoat materials by electrostatic spray application and pneumatic spray application without the need for conversion work. In addition it was possible by virtue of the process of the invention, in finishing plants to be erected from new, to dispense entirely with an installation for applying surfacers.

### DETAILED DESCRIPTION OF THE PROCESS OF THE INVENTION

The process of the invention serves for producing multicoat color and/or effect paint systems on any of a wide variety of substrates.

As is known these multicoat paint systems comprise—atop one another in this order—
(A) at least one first color and/or effect coat,
(B) at least one second color and/or effect coat, and
(C) at least one transparent coat.

As is known they are produced by successively applying at least one physically or thermally curable aqueous coating material (A), at least one thermally curable aqueous coating material (B), and at least one coating material (C) to
(i) an unprimed substrate,
(ii) a substrate coated with at least one uncured or only part-cured primer (G) or
(iii) a substrate coated with at least one full-cured primer (G)
   and jointly curing
(1) the resulting wet films (A), (B), and (C), or
(2) (A), (B), and (C) and the uncured or only part-cured primer(s) (G).

Processes of this kind are known for example from German patent application DE 44 38 504 A 1, page 4, line 62 to page 5, line 20 and page 5, line 59 to page 6, line 9, and from German patent application DE 199 48 004 A 1, page 17, line 59 to page 19, line 22 and page 22, lines 13 to 31, in conjunction with Table 1, page 21.

For the process of the invention it is essential that the physically or thermally curable aqueous basecoat material (A) used comprises as essential constituent at least one, especially one, (co)polymer or graft copolymer (a.1).

For the purposes of the present invention a (co)polymer (a.1) is a homopolymer or a copolymer which has been prepared from at least one monomer (a.1.1) in the presence of polyurethane (a.1.2) preferably by thermally initiated free-radical (co)polymerization, but whose polymer or copolymer chains are predominantly not linked to the polymer main chains of the polyurethane (a.1.2) by covalent bonds. “Predominantly” here means that more than 50% and up to 100% of the polymer or copolymer chains present are not linked to the polymer main chains of the polyurethane (a.1.2).

Conversely for the purposes of the present invention a graft copolymer (a.1) is a homopolymer or a copolymer which has been prepared from at least one monomer (a.1.1) in the presence of polyurethane (a1.2) preferably by thermally initiated free-radical (co)polymerization and whose polymer or copolymer chains are predominantly linked to the polymer main chains of the polyurethane (a.1.2) by covalent bonds. “Predominantly” here means that more than 50% and up to 100% of the polymer or copolymer chains present are linked to the polymer main chains of the polyurethane (a.1.2)

The (co)polymer or graft copolymer is preparable by (co)polymerizing a monomer (a.1 1) containing at least one (co)polymerizable, olefinically unsaturated group, or at least two comonomers (a1.1), in the presence of at least one polyurethane (a.1.2) selected from the group consisting of polyurethanes containing no copolymerizable, olefinically unsaturated groups and polyurethanes containing at least one lateral and/or at least one terminal copolymerizable, olefinically unsaturated group, and optionally carrying out partial or complete neutralization.

Preferably the polyurethanes (a1.2) containing no copolymerizable, olefinically unsaturated groups are used for preparing the (co)polymers (a.1).

Preferably the polyurethanes (a.1.2) containing at least one lateral and/or at least one terminal copolymerizable, olefinically unsaturated group are used for preparing the graft copolymers (a.1).

In the process of the invention it is preferred to use the graft copolymers (a.1).

The (co)polymerization or graft copolymerization is preferably conducted in organic solution or in aqueous dispersion, in particular in aqueous dispersion. Preference is given to using (co)monomers (a.1.1) which are free from acid groups. The (co)polymerizable, olefinically unsaturated groups of the (co)monomers (a.1.1) are preferably selected from the group consisting of (meth)acrylate, ethacrylate, crotonate, cinnamate, vinyl, vinyl ether, vinyl ester, dicyclopentadienyl, norbornenyl, isoprenyl, isopropenyl, allyl or butenyl groups, dicyclopentadienyl ether, norbornenyl ether, isoprenyl ether, isopropenyl ether, vinyl ether, allyl ether or butenyl ether groups, or dicyclopentadienyl ester, norbornenyl ester, isoprenyl ester, isopropenyl ester, vinyl ester, allyl ester or butenyl ester groups. In particular the groups in question are (meth)acrylate groups. Suitable (co)monomers (a.1.1) are known, for example, from German patent application DE 199 48 004 A 1, page 11, line 30, to page 12, line 60.

Preferably the copolymerizable, olefinically unsaturated groups of the polyurethane (a1.2) are selected from the group consisting of (meth)acrylate, ethacrylate, crotonate, cinnamate, vinyl, vinyl ether, vinyl ester, dicyclopentadienyl, norbornenyl, isoprenyl, isopropenyl, allyl or butenyl groups, dicyclopentadienyl ether, norbornenyl ether, isoprenyl ether, isopropenyl ether, vinyl ether, allyl ether or butenyl ether groups, or dicyclopentadienyl ester, norbornenyl ester, isoprenyl ester, isopropenyl ester, vinyl ester, allyl ester or butenyl ester groups. The groups in question are preferably vinyl groups. In particular the vinyl groups are contained in ethenylarylene groups.

The preparation of the (co)polymers (a.1) is known per se and is described in detail for example in German patent application DE 44 37 535 A 1, page 2 line 27 to page 6 line 22.

The preparation of the graft copolymers (a.1) is likewise known per se and is described in detail for example in the following patent applications:
WO 98/54266 A 1, page 3 line 28 to page 4 line 21, page 5 line 14 to page 6 line 6, page 6 line 8 to page 7 line 3, page 7 line 25 to page 22 line 13, page 22 line 19 to page 29, page 32 line 10 to page 33 line 9, “Example 1: aqueous dispersion of the binder component a)”, and page 33 line 12 to page 34 line 10, “Example 2: aqueous dispersion of the binder component b)”;
EP 0 522 419 A 1, column 1 lines 27 to 48, column 1 line 49 to column 2 line 13, column 2 lines 14 to 41, column 2 lines 42 to 56, column 2 line 57 to column 8 line 57, column 8 line 58 to column 9 line 55, column 10 line 5 to column 12 line 53, and column 14 line 42 to column 17 line 11;
EP 0 522 420 A 2, column 1 line 19 to column 8 line 7, column 8 line 15 to column 9 line 38, and column 11 line 28, column 14 line 10;
DE 100 39 262 A 1, page 4 paragraph [0027] to page 9 paragraph [0101], page 9 paragraph [0107] to page 12 paragraph [0129], page 17 paragraph [0193] and page 18 paragraph [0194]; and
DE 199 48 004 A 1, p 4 line 19 to page 10 line 38, page 10 line 42 to page 13 line 48, page 19 lines 44 to 54, “Preparation Example 1—the preparation of an adduct (B2) for inventive use”, page 19 line 56 to page 20 line 7, “Example 1—the preparation of an inventive polyurethane (B)”, and page 20 lines 9 to 21, “Example 2—the preparation of the primary dispersion of an inventive graft copolymer 1”.

Use is made in particular of the graft copolymers 1 and 2 described in detail in German patent application DE 199 48 004 A 1, particularly the graft copolymers 1, which comprise a hydrophobic core comprising at least one copolymerized olefinically unsaturated monomer and a hydrophilic shell comprising at least one hydrophilic polyurethane, as graft copolymers (a.1) (cf. DE 199 48 004 A1 on page 10 lines 42 to 57 in conjunction with page 4 lines 12 to 18).

Accordingly the polyurethane for use in the process of the invention is preferably prepared by
(1) reacting at least one polyurethane prepolymer (a.1.2.1) containing at least one free isocyanate group with
(2) at least one adduct (a.1.2.2) obtainable by reacting at least one ethenylarylene monoisocyanate and at least one compound containing at least two isocyanate-reactive functional groups with one another such that at least one isocyanate-reactive functional group remains in the adduct (a1.2.2).

The isocyanate-reactive functional group is preferably selected from the group consisting of hydroxyl groups, thiol groups and primary and secondary amino groups.

Preferably the ethenylarylene monoisocyanate has the general formula I:

CH₂—C(R)—A—X—NCO (I)

in which the definition of the variables is as follows:
A=substituted or unsubstituted C₆-C₂₀ arylene radical;
R—hydrogen atom, halogen atom, nitrile group or a substituted or unsubstituted alkyl, cycloalkyl, alkylcycloalkyl, cycloalkylalkyl, aryl, alkylaryl, cycloalkylaryl, arylalkyl or arylcycloalkyl radical; and
X=divalent organic radical.

The arylene radical A is preferably 1,2-, 1,3- and/or 1,4-phenylene, especially 1,3-phenylene.

R is preferably a hydrogen atom or a methyl group, in particular a methyl group.

The divalent organic radical X preferably designates a branched or unbranched C₃-C₆ alkanediyl radical.

The divalent organic radical X is preferably —C(CH₃)₂—.

In particular the ethenylarylene monoisocyanate I or at least one of the ethenylarylene monoisocyanates I is 1-(1-isocyanato-1-methylethyl)-3-(1-methylethenyl)benzene.

In particular the polyurethane (a.1.2) contains hydrophilic functional groups, especially carboxylic acid groups and/or carboxylate groups.

(cf. in detail DE 199 48 004 A 1: page 6 line 34 to page 7 line 48, page 8 line 5 to page 9 line 40)

The graft copolymerization is preferably conducted as described in DE 199 48 004 A 1, page 12 line 62 to page 13 line 48.

For use in the aqueous basecoat material (A) for use in accordance with the invention the (co)polymer or graft copolymer (a.1), especially the graft copolymer (a.1), is partly or fully neutralized, whereby some or all of the potentially anionic groups, i.e., of the acid groups, are converted into anionic groups. Suitable neutralizing agents are known from DE 44 37 535 A 1, page 6, lines 7 to 16 or DE 199 48 004 A 1, page DE 199 48 004 A 1, page 7, lines 4 to 8.

The amount of (co)polymer or graft copolymer (a.1) in the aqueous basecoat material (A) for use in accordance with the invention may vary very widely and is guided by the requirements of the case in hand. The amount of (a.1) in (A), based on the solids of (A), is preferably from 5 to 50% by weight, in particular from 10 to 40% by weight.

The aqueous basecoat material (A) for use in accordance with the invention comprises at least one color and/or effect pigment (a.2). The pigment (a.2) is preferably selected from the group consisting of organic and inorganic pigments, color pigments, optical effect pigments, color and optical effect pigments, magnetically shielding pigments, electrically conductive pigments, anticorrosion pigments, fluorescent pigments and phosphorescent pigments, in particular from the group consisting of organic and inorganic color pigments, optical effect pigments, and color and optical effect pigments.

Examples of suitable effect pigments, which may also provide color, include metal flake pigments, such as commercially customary aluminum bronzes, aluminum bronzes chromated as per DE 36 36 183 A 1, and commercially customary stainless steel bronzes, and also nonmetallic effect pigments, such as pearlescent pigments and interference pigments, platelet-shaped effect pigments based on iron oxide with a hue from pink to brownish red, or liquid-crystalline effect pigments. For further details refer to Römpp Lexikon Lacke and Druckfarben, Georg Thieme Verlag, 1998, page 176, “effect pigments” and pages 380 and 381, “metal oxide-mica pigments” to “metal pigments”, and to the patent applications and patents DE 36 36 156 A 1, DE 37 18 446 A 1, DE 37 19 804 A 1, DE 39 30 601 A 1, EP 0 068 311 A 1, EP 0 264 843 A 1, EP 0 265 820 A 1, EP 0 283 852 A 1, EP 0 293 746 A 1, EP 0 417 567 A 1, U.S. Pat. No. 4,828,826 A or U.S. Pat. No. 5,244,649 A.

Examples of suitable inorganic color pigments are white pigments such as zinc white, zinc sulfide or lithopones; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinal phases and corundum phases or chromium orange; or yellow iron oxide, nickel titanium yellow, chromium titanium yellow, cadmium sulfide, cadmium zinc sulfide, chromium yellow or bismuth vanadate.

Examples of suitable organic color pigments are monoazo pigments, biazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments or aniline black

For further details refer to Römpp Lexikon Lacke and Druckfarben, Georg Thieme Verlag, 1998, pages 180 and 181, “iron blue pigments” to “black iron oxide”, pages 451 to 453, “pigments” to “pigment volume concentration”, page 563, “thioindigo pigments”, page 567, “titanium dioxide pigments”, pages 400 and 467, “naturally occurring pigments”, page 459, “polycyclic pigments”, page 52, “azomethine pigments”, “azo pigments”, and page 379, “metal complex pigments”.

Examples of fluorescent and phosphorescent pigments (daylight-fluorescent pigments) are bis(azomethine) pigments.

Examples of suitable electrically conductive pigments are titanium dioxide/tin oxide pigments.

Examples of magnetically shielding pigments are pigments based on iron oxides or chromium dioxide.

Examples of suitable anticorrosion pigments are lead silicates, zinc phosphates or zinc borates.

The amount of the pigments (a.2) in the aqueous basecoat material (A) may vary very widely and is guided primarily by the intensity of the effects, in particular of the optical effects, and/or the shade which is or are to be produced.

In accordance with the invention the aqueous basecoat material (A) comprises at least one UV-absorbing pigment (a.3), in particular two UV-absorbing pigments (a.3).

The UV-absorbing pigments (a.3) are preferably selected from the group consisting of titanium dioxide pigments and carbon black pigments. It is preferred to use at least one titanium dioxide pigment (a.3) and at least one carbon black pigment (a.3).

The amount of titanium dioxide and/or carbon black pigments (a.3) in (A) may vary very widely and is guided by the requirements of the case in hand, in particular by the degree of transmission of the UV radiation brought about by the pigments (a.2) in the basecoats (A) and (B).

The titanium dioxide pigment (a.3) content of (A), based on the solids of (A), is preferably from 0.1 to 5% by weight, in particular from 0.5 to 3% by weight.

The carbon black pigment (a.3) content of (A), based on the solids of (A), is preferably from 0.001 to 2% by weight, in particular from 0.01 to 1% by weight.

In accordance with the invention the aqueous basecoat material (A) comprises at least one, especially one, talc pigment (a.4). The amount of talc (a.4) in (A) may vary very widely and is guided by the requirements of the case in hand. The amount of (a.4) in (A), based on the solids of (A), is preferably from 0.1 to 5% by weight, in particular from 0.5 to 3% by weight. The aqueous basecoat material (A) for use in accordance with the invention may further comprise at least one conventional additive (a.5) in effective amounts. The additive or additives (a.5) is or are preferably selected from the group consisting of crosslinking agents; oligomeric and polymeric binders other than the (co)polymers or graft copolymers (a.1), including polyurethanes, which are described in the documents listed below in connection with the aqueous basecoat materials (B); organic and inorganic, chromatic and achromatic, transparent and opaque pigments, fillers, and nanoparticles other than the pigments (a.2) to (a.4); organic solvents; driers; antisettling agents; UV absorbers; light stabilizers; free-radical scavengers; devolatilizers; slip additives; polymerization inhibitors; defoamers; emulsifiers; wetting agents; adhesion promoters; leveling agents; film-forming auxiliaries; rheology control additives; and flame retardants.

Examples of suitable additives (a.5) are described in German patent application DE 199 48 004 A 1, page 14, line 32 to page 17, line 5.

In terms of method the preparation of the aqueous basecoat material (A) for use in accordance with the invention has no particular features but instead takes place preferably by the mixing of the above-described constituents and homogenization of the resulting mixtures using conventional mixing techniques and equipment such as stirred tanks, stirrer mills, extruders, compounders, ultraturrax, inline dissolvers, static mixers, toothed-wheel dispersers, pressure release nozzles and/or microfluidizers.

Although the aqueous basecoat material (A) can be applied by any conventional method of applying liquid coating materials, it is an advantage of the process of the invention if it is applied with the aid of electrostatic spray application (ESTA), preferably with high-speed rotating bells. It is preferably applied at a wet film thickness such that after the resulting basecoat film (A) has been cured the resulting dry film has a thickness of from 6 to 30 μm, in particular from 8 to 25 μm.

In the process of the invention the aqueous basecoat film (A) is coated immediately with the thermally curable aqueous coating material (B). Alternatively it is first flashed off or dried, but without curing, or with only partial curing, and then coated with the thermally curable aqueous coating material (B).

The thermally curable aqueous coating material (B) is preferably a customary and known aqueous basecoat material as is known, for example, from American patent U.S. Pat. No. 5,114,789 A, column 7, line 41 to column 8, line 33, column 11, lines 24 to 50, and column 13, lines 30 to 40, from European patent EP 0 352 298 B 1, page 9, line 19 to page 12, line 38, or from patent applications EP 0 089 497 A 1, EP 0 256 540 A 1, EP 0 260 447 A 1, EP 0 297 576 A 1, WO 96/12747, EP 0 523 610 A 1, EP 0 228 003 A 1, EP 0 397 806 A 1, EP 0 574 417 A 1, EP 0 531 510 A 1, EP 0 581 211 A 1, EP 0 708 788 A 1, EP 0 593 454 A 1, DE 43 28 092 A 1, EP 0 299 148 A 1, EP 0 394 737 A1, EP 0 590 484 A 1, EP 0 234 362 A 1, EP 0 234 361 A 1, EP 0 543 817 A 1, WO 95/14721, EP 0 521 928 A 1, EP 0 649 865 A 1, EP 0 536 712 A 1, EP 0 596 460 A 1, EP 0 596 461 A 1, EP 0 584 818 A 1, EP 0 669 356 A 1, EP 0 634 431 A 1, EP 0 678 536 A 1, EP 0 354 261 A 1, EP 0 424 705 A 1, WO 97/49745, WO 97/49747, EP 0 401 565 A 1, EP 0 496 205 A 1, EP 0 358 979 A 1, EP 469 389 A 1, DE 24 46 442 A 1, DE 34 09 080 A 1, DE 195 47 944 A 1, DE 197 41 554 A 1 or EP 0 817 684, column 5, lines 31 to 45.

In particular an aqueous basecoat material (B) is used which except for the presence of titanium dioxide and talc is substantially or completely identical to the aqueous basecoat material (A) for use in accordance with the invention. This represents a particular advantage of the process of the invention, since in this case the aqueous basecoat material (A) can be readily prepared by adding titanium dioxide and talc to the aqueous basecoat material (B).

Although the aqueous basecoat material (B) can be applied by any of the conventional methods of applying liquid coating materials, it is nevertheless an advantage for the process of the invention if it is applied with the aid of pneumatic spray application. It is preferably applied in a wet film thickness such that curing of the resultant basecoat film (A) results in a dry film thickness of from 4 to 25 μm, in particular from 6 to 20 μm.

In the process of the invention the aqueous basecoat film (B) is immediately coated with the coating material (C). Or alternatively it is first flashed off or dried, but without curing or with only partial curing, and then coated with the coating material (C).

The aqueous basecoat materials (A) and (B) are preferably applied with a wet film thickness such that the dry film thickness (A+B) after curing totals from 10 to 40 μm, in particular from 12 to 35 μm

The coating material (C) is a transparent, in particular optically clear, coating material which is curable thermally and/or with actinic radiation, in particular a clearcoat material.

Actinic radiation means electromagnetic radiation, such as near infrared (NIR), visible light, UV radiation, x-rays, and gamma radiation, especially UV radiation, and corpuscular radiation, such as electron beams, beta radiation, proton beams, neutron beams, and alpha radiation, especially electron beams.

Suitable clearcoat materials (C) include all customary and known one-component (1K), two-component (2K) or multicomponent (3K, 4K) clearcoat, powder clearcoat, powder slurry clearcoat or UV-curable clearcoat materials.

Thermally curable one-component (1K), two-component (2K) or multicomponent (3K, 4K) clearcoat materials (C) are known from patent applications DE 42 04 518 A 1, EP 0 594 068 A 1, EP 0 594 071 A 1, EP 0 594 142 A 1, EP 0 604 992 A 1 or EP 0 596 460 A 1, from international patent applications WO 94/10211, WO 94/10212, WO 94/10213, WO 94/22969 or WO 92/22615 or from American patents U.S. Pat. No. 5,474,811 A, U.S. Pat. No. 5,356,669 A or U.S. Pat. No. 5,605,965 A.

One-component (1K) clearcoat materials (C) comprise, as is known, hydroxyl-containing binders and crosslinking agents such as blocked polyisocyanates, tris(alkoxycarbonylamino)triazines and/or amino resins. In another version they comprise as binders polymers containing pendant carbamate and/or allophanate groups, and carbamate- and/or allophanate-modified amino resin crosslinking agents (cf. American patents U.S. Pat. No. 5,474,811 A, U.S. Pat. No. 5,356,669 A or U.S. Pat. No. 5,605,965 A 1, international patent applications WO 94/10211, WO 94/10212 or WO 94/10213 or European patent applications EP 0 594 068 A 1, EP 0594 071 A 1 or EP 0 594 142 A 1).

Two-component (2K) or multicomponent (3K, 4K) clearcoat materials (B.2) include as essential constituents, as is known, hydroxyl-containing binders and polyisocyanate crosslinking agents, which are stored separately prior to their use.

Thermally curable powder clearcoat materials (C) are known, for example, from German patent application DE 42 22 194 A 1, the BASF Lacke+Farben AG product information “Pulverlacke”, 1990, or the BASF Coatings AG brochure “Pulverlacke, Pulverlacke für industrielle Anwendungen”, January 2000.

Powder clearcoat materials (C) are known to include as essential constituents epoxy-functional binders and polycarboxylic acid crosslinking agents.

Examples of suitable powder slurry clearcoat materials (C) are known from U.S. Pat. No. 4,268,542 A 1 and from patent applications DE 195 40 977 A 1, DE 195 18 392 A 1, DE 196 17 086 A 1, DE 196 13 547 A 1, EP 0 652 264 A 1, DE 196 18 657 A 1, DE 196 52 813 A 1, DE 196 17 086 A 1 or DE 198 14 471 A 1.

Powder slurry clearcoat materials (C) familiarly comprise powder clearcoat materials (B.2) in dispersion in an aqueous medium.

Clearcoat, powder clearcoat, and powder slurry clearcoat materials (C) curable with actinic radiation are disclosed for example by European patent applications EP 0 928 800 A 1, EP 0 636 669 A 1, EP 0 410 242 A 1, EP 0 783 534 A 1, EP 0 650 978 A 1, EP 0 650 979 A 1, EP 0 650 985 A 1, EP 0 540 884 A 1, EP 0 568 967 A 1, EP 0 054 505 A 1 or EP 0 002 866 A 1, by German patent applications DE 199 17 965 A 1, DE 198 35 206 A 1, DE 197 09 467 A 1, DE 42 03 278 A 1, DE 33 16 593 A 1, DE 38 36 370 A 1, DE 24 36 186 A 1 or DE 20 03 579 B 1, by international patent applications WO 97/46549 or WO 99/14254 or by American patents U.S. Pat. No. 5,824,373 A, U.S. Pat. No. 4,675,234 A, U.S. Pat. No. 4,634,602 A, U.S. Pat. No. 4,424,252 A, U.S. Pat. No. 4,208,313 A, U.S. Pat. No. 4,163,810 A, U.S. Pat. No. 4,129,488 A, U.S. Pat. No. 4,064,161 A or U.S. Pat. No. 3,974,303 A.

Clearcoat, powder clearcoat, and powder slurry clearcoat materials (C) curable thermally and with actinic radiation are disclosed for example by patent applications DE 198 18 735 A 1, WO 98/40170, DE 199 08 013 A 1, DE 199 08 018 A 1, EP 0 844 286 A 1 or EP 0 928 800 A 1.

It is preferred to use thermally curable clearcoat materials (C) or clearcoat materials (C) curable both thermally and with actinic radiation.

The clearcoat material (C) that is selected for the process of the invention is applied by means of the conventional application techniques, which are adapted to the aggregate state (liquid or pulverulent) of the clearcoat material (C).

The coating materials (A), (B) and (C) can be applied to
(i) unprimed substrates,
(ii) substrates coated with at least one, especially one, uncured or only part-cured primer (G) or
(iii) substrates coated with at least one, especially one, full-cured primer (G).

The substrates may be composed of any of a very wide variety of materials and combinations of materials. They are preferably composed of metals, plastics, glass, wood, leather, textile, ceramic or natural stone, preferably of metals, plastics, and glass, and in particular of metals and plastics.

The substrates may have any of a very wide variety of end uses. The substrates are preferably bodies of means of transport, including watercraft, rail vehicles, aircraft, muscle-powered vehicles and motor vehicles, especially automobiles, motor cycles, trucks and buses, and parts thereof; buildings and parts thereof; doors, windows; furniture; small industrial parts; mechanical, optical, and electronic components; coils, containers; packaging, hollow glassware, and articles of everyday use.

The substrates are in particular bodies of automobiles and parts thereof.

The bodies have preferably been provided with a primer (G).

Where the bodies are made of steel, customary and known electrocoats are used as primers (G). The electrocoats (G) are produced in conventional manner from electrophoretically depositable, especially cathodically depositable, electrocoat materials. The resultant electrocoat films (G) can be cured thermally prior to the application of the aqueous basecoat material (A). Alternatively they can merely be dried, without curing or with only partial curing, and then cured jointly with the other films (A), (B) and (C).

Where the bodies are made of aluminum, the primers (G) are layers of aluminum oxide produced by anodic oxidation, which as such require no further curing step.

Where parts of the bodies, i.e., what are called exterior mounted components, are composed of plastics, they are preferably provided with a customary and known water-based primer (G), or the adhesion properties of their surface are enhanced using chemical and/or physical techniques. In these cases too it is generally unnecessary to cure the primers (G).

In the process of the invention the applied films (A), (B) and (C) are jointly cured thermally. Where the clearcoat material (C) is also curable with actinic radiation, an aftercure takes place by exposure to actinic radiation. Where the primer (G), used where appropriate, has not yet been cured, it is cured as well in this separate process.

Curing may take place after a certain rest time. This may have a duration of from 30 seconds to 2 hours, preferably from 1 minute to 1 hour and in particular from 1 to 45 minutes. The rest time is used, for example, for the leveling and devolatilization of the paint films or for the evaporation of volatile constituents. The rest time can be assisted and/or shortened through the use of elevated temperatures of up to 90° C. and/or through a reduced atmospheric humidity<10 g water/kg air, in particular <5 g/kg air, provided this does not entail any damage to or change in the paint films, such as a premature complete crosslinking

The thermal cure has no particular features as far as this method is concerned, but instead takes place in accordance with the conventional methods such as heating in a forced air oven or irradiation with IR lamps. The thermal cure here may also take place in stages. Another preferred method of curing is that of curing with near infrared (NIR) radiation. Particular preference is given to employing a process in which the water constituent is removed rapidly from the wet films Suitable processes of this kind are described by, for example, Rodger Talbert in Industrial Paint & Powder, 04/01, pages 30 to 33, “Curing in Seconds with NIR”, or in Galvanotechnik 90 (11), pages 3098 to 3100, “Lackiertechnik, NIR-Trocknung im Sekundentakt von Flüssig-und Pulverlacken”.

The thermal cure takes place advantageously at a temperature of from 50 to 170° C., more preferably from 60 to 165° C., and in particular from 80 to 150° C. for a time of from 1 minute up to 2 hours, more preferably from 2 minutes up to 1 hour, and in particular from 3 to 30 minutes.

The thermal cure can be supplemented by the actinic radiation cure, in particular with UV radiation. In this case it is possible to employ the conventional methods and apparatus, as described for example in German patent application DE 199 20 799 A 1, page 11, lines 5 to 21.

The resultant multicoat color and/or effect paint systems are of outstanding automobile quality, and so can also be considered for the finishing of top class automobiles. They have an outstanding stonechip resistance, which does not decrease even following long exposure to sunlight

### EXAMPLES AND COMPARATIVE EXAMPLES

### Preparation Example 1

### The Preparation of an Adduct Containing an Ethenylarylene Group (a.1.2,2)

A reaction vessel equipped with stirrer, internal thermometer, reflux condenser and electrical heating was charged with 429 parts by weight of methyl ethyl ketone, 182 parts by weight of N-methylpyrrolidone and 210 parts by weight of diethanolamine at 20° C. Added dropwise to this mixture over the course of one and a half hours were 402 parts by weight of 1-(1-isocyanato-1-methylethyl)-3-(1 -methylethenyl)benzene (TMI® from CYTEC), addition taking place at a rate such that the reaction temperature did not exceed 40° C. The resulting reaction mixture was stirred until free isocyanate groups were no longer detectable. Thereafter it was stabilized with 200 ppm of hydroquinone. The solids content of the reaction mixture was 50% by weight.

### Preparation Example 2

### The Preparation of a Hydrophilic Polyurethane (a.1.2)

In a reaction vessel equipped with stirrer, internal thermometer, reflux condenser and electrical heating, 664.4 parts by weight of a linear polyester polyol (prepared from dimerized fatty acid (Pripol® 1013), isophthalic acid and hexane-1,6-diol) having a hydroxyl number of 80 and a number-average molecular weight of 1400 daltons and 89.4 parts by weight of dimethylolpropionic acid were dissolved in 342 parts by weight of methyl ethyl ketone and 52 parts by weight of N-methylpyrrolidone. Added to the resultant solution at 45° C. were 296.2 parts by weight of isophorone diisocyanate. After the exothermic reaction had subsided the reaction mixture was slowly heated with stirring to 80° C. Stirring of the reaction mixture was continued at this temperature until the isocyanate content was 1.2% by weight and was constant. Thereafter the reaction mixture was cooled to 70° C. and 248 parts by weight of the adduct (a.1.2.2) from Preparation Example 1 were added. The resulting reaction mixture was stirred at 70° C. until free isocyanate groups were no longer detectable. The resultant dissolved polyurethane (a.1.2) was admixed with 142 parts by weight of methoxypropanol and 57 parts by weight of triethylamine 30 minutes after the amine addition, the temperature of the solution was lowered to 60° C., after which 1791 parts by weight of deionized water were added with stirring over the course of 30 minutes. The methyl ethyl ketone was removed from the resulting dispersion by vacuum distillation at 60° C. Subsequently any losses of solvent and water were compensated. The resulting dispersion of the polyurethane (a.1.2) had a solids content of 35.1% by weight (one hour at 130° C.) and a pH of 7.3.

### Preparation Example 3

### The Preparation of the Primary Dispersion of a Graft Copolymer (a.1)

1495.7 parts by weight of the polyurethane dispersion (a.1.2) from Preparation Example 2 were diluted with 851.6 parts by weight of deionized water and heated to 85° C. At this temperature the dispersion was admixed, with stirring, with a mixture of 150.2 parts by weight of styrene, 150.2 parts by weight of methyl methacrylate, 112.4 parts by weight of n-butyl acrylate and 112.4 parts by weight of hydroxyethyl methacrylate, addition taking place at a uniform rate over the course of 3.5 hours. Commencing simultaneously with the addition of the monomer mixture was the addition of a solution of 7.9 parts by weight of tert-butyl peroxyethylhexanoate in 115.5 parts by weight of methoxypropanol, which was completed over the course of four hours. The resulting reaction mixture was stirred further thereafter at 85° C. until all of the monomers had reacted. The resulting primary dispersion of the graft copolymer (a.1) had a very good storage stability. Its solids content was 34.9% by weight (one hour at 130° C.) and its pH was 7.2.

### Preparation Example 4

### The Preparation of an Aqueous Basecoat Material (B)

The aqueous basecoat material (B) was prepared using the primary dispersion of the graft copolymer (a.1) from Preparation Example 3 in accordance with the instructions given in German patent application DE 199 48 004 A 1, page 20 line 51 to page 21 line 18 in conjunction with Table 1, page 21, “Example 3 and Comparative Examples C2 and C3”.

### Preparation Example 5

### The Preparation of an Aqueous Basecoat Material (A)

For the preparation of the aqueous basecoat material (A) first of all
a talc paste was produced from—based on the paste—30% by weight of talc and 70% by weight of the primary dispersion of the graft copolymer (a.1) from Preparation Example 3,
a titanium dioxide paste was produced from—based on the paste—50% by weight of titanium dioxide and 50% by weight of the primary dispersion of the graft copolymer (a.1) from Preparation Example 3 and
a carbon black paste was produced from—based on the paste—10% by weight of Monarch® 1400 carbon black and 90% by weight of the primary dispersion of the graft copolymer (a.1) from Preparation Example 3.

6 parts by weight of talc paste, 6 parts by weight of the titanium dioxide paste, and 0.075 part by weight of the carbon black paste were added with stirring to the aqueous basecoat material (B) from Preparation Example 4, so producing the aqueous basecoat material (A).

### Example 1 (Inventive) and Examples C1 and C2 (Comparative)

### The Production of Multicoat Effect Paint Systems

Example 1 was carried out using the aqueous basecoat material (A) from Preparation Example 5, the aqueous basecoat material (B) from Preparation Example 4, and a commercial one-component clearcoat material (C) from BASF Coatings AG.

For Example C1 only the aqueous basecoat material (B) from Preparation Example 4, for the production of the effect coats (A) and (B), and the commercial one-component clearcoat material (C) from BASF Coatings AG were used.

For Example C2 a commercial baking surfacer from BASF Coatings AG, the aqueous basecoat material (B) from Preparation Example 4, and the commercial one-component clearcoat material (C) from BASF Coatings AG were used

The substrates used were steel test panels measuring 20×20 cm which had been coated with a customary and known electrocoat in a dry film thickness of 20 μm.

For Example 1, first of all the aqueous basecoat material (A) from Preparation Example 5 was applied by electrostatic spray application (ESTA) in a wet film thickness such that curing resulted in a dry film thickness of 10 μm. The resulting basecoat film (A) was flashed off for 4 minutes and then coated with the aqueous basecoat material (B) from Preparation Example 4 by pneumatic spray application in a wet film thickness which resulted after curing in a dry film thickness of 7 μm. The basecoat films (A) and (B) were dried at 80° C. for 10 minutes. Thereafter the clearcoat material (C) was applied in a wet film thickness such that curing gave a dry film thickness of 40 μm. The clearcoat film (C) was flashed off for 5 minutes Subsequently the films (A), (B) and (C) were baked in a forced air oven at 130° C. for 30 minutes.

For Example C1 Example 1 was repeated but using the aqueous basecoat material (B) from Preparation Example 4 instead of the aqueous basecoat material (A) from Preparation Example 5.

For Example C2 Example 1 was repeated but using the commercially customary baking surfacer instead of the aqueous basecoat material (A) from Preparation Example 5 and applying it in a wet film thickness such that curing gave a dry film thickness of 30 μm, and baking it, prior to the application of the aqueous basecoat material (B) from Preparation Example 4, in a forced air oven at 150° C. for 20 minutes

The stonechip resistance of the resulting multicoat effect paint systems was determined by means of the VDA [German Automakers' Association] stonechip test and of the DaimlerChrysler ball shot test. The results are given in Table 1. They underline the fact that even at a dry film thickness of just 10 μm the aqueous basecoat (A) was able fully to replace a surfacer coat in a dry film thickness of 30 μm.

TABLE 1
DaimlerChrysler and VDA stonechip resistance

| | Example: | | |
|---|---|---|---|
| Test | C1 | C2 | Example 1 |
| VDA^{a)} | 2/2 | 2/1 | 2/1 |
| Ball shot^{b)} | 4/5 | 7/1 | 6/1 |

^{a)}Target: 2/1; 1st number = impact-abraded area (mm²); 2nd number = area of abrasion down to substrate (mm²);
^{b)}Target: 8/1; 1st number = impact-abraded area (mm²); 2nd number = area of abrasion down to substrate (mm²).

### Example 2 (Inventive) and Examples C3 and C4 (Comparative)

### The Production of Self-Supporting Multicoat Effect Paint Systems

For Example 2 Example 1 was repeated.

For Example C3 Example C1 was repeated.

For Example C4 Example C2 was repeated.

In Examples 2 and C3 and C4 the steel panels were replaced by Stamylan panels, so that the resultant multicoat effect paint systems could be detached from the substrate as self-supporting films. The transmission of UV radiation (in %) of the self-supporting films was measured. The results are given in Table 2. They underline the fact that even at a dry film thickness of just 10 μm the aqueous basecoat (A) was able fully to replace a surfacer coat in a dry film thickness of 30 μm with respect to suppressing the transmission of UV radiation as well.

TABLE 2
Transmission of UV radiation, measured on self-supporting films

| UV radiation: | Transmission (%): | | |
|---|---|---|---|
| Wavelength | Example: | | |
| (nm) | C3 | C4 | Example 2 |
| 290 to 380 ^{a)} | 1.8 | 0 | 0.02 |
| 380 to 400 ^{b)} | 4.0 | 0 | 0.04 |
| 400 to 450 ^{c)} | 5.8 | 0 | 0.04 |

^{a)} Target: <0.2%;
^{b)} Target: <1.0%;
^{c)} Target: <2.0%.

1. A process for producing multicoat color and/or effect paint systems on substrates, said paint systems comprising—atop one another in the following order
(A) at least one first color and/or effect coat,
(B) at least one second color and/or effect coat, and
(C) at least one transparent coat,
said process comprising applying at least one physically or thermally curable aqueous coating material (A), at least one thermally curable aqueous coating material (B), and at least one coating material (C) to at least one of
(i) an unprimed substrate,
(ii) a substrate coated with at least one uncured or only part-cured primer (G) or
(iii) a substrate coated with at least one full-cured primer (G)
and jointly curing
(1) the resulting wet films (A), (B), and (C), or
(2) (A), (B), and (C) and the uncured or only part-cured primer(s) (G),
wherein the coating material (A) comprises
(a.1) at least one (co)polymer or graft copolymer prepared by (co)polymerizing (a.1.1) monomer containing at least one copolymerizable, olefinically unsaturated group or at least two comonomers in the presence of at least one polyurethane (a.1.2) selected from the group consisting of polyurethanes containing no copolymerizable, olefinically unsaturated groups, polyurethanes containing at least one lateral, copolymerizable, olefinically unsaturated group and polyurethanes containing at least one terminal copolymerizable, olefinically unsaturated group, and optionally carrying out partial or complete neutralization,
(a.2) at least one color or effect pigment,
(a.3) at least one UV-absorbing pigment, and
(a.4) talc.

2. The process as claimed in claim 1, wherein the (co)polymerizable, olefinically unsaturated groups of the (co)monomers (a.1.1) are selected from the group consisting of (meth)acrylate, ethacrylate, crotonate, cinnamate, vinyl, vinyl ether, vinyl ester, dicyclopentadienyl, norbornenyl, isoprenyl, isopropenyl, ally, butenyl, dicyclopentadienyl ether, norbornenyl ether, isoprenyl ether, isopropenyl ether, vinyl ether, allyl ether, and butenyl ether, dicyclopentadienyl ester, norbornenyl ester, isoprenyl ester, isopropenyl ester, vinyl ester, ally ester and butenyl ester groups and mixtures thereof.

3. The process as claimed in claim 1, wherein the polyurethane (a.1.2) comprises at least one of a lateral copolymerizable, olefinically unsaturated group or a terminal copolymerizable, olefinically unsaturated group.

4. The process as claimed in claim 3, wherein the copolymerizable, olefinically unsaturated groups of the polyurethane (a.1.2) are selected from the group consisting of (meth)acrylate, ethacrylate, crotonate, cinnamate, vinyl, vinyl ether, vinyl ester, dicyclopentadienyl, norbornenyl, isoprenyl, isopropenyl, allyl, butenyl, dicyclopentadienyl ether, norbornenyl ether, isoprenyl ether, isopropenyl ether, vinyl ether, allyl ether, butenyl ether, dicyclopentadienyl ester, norbornenyl ester, isoprenyl ester, isopropenyl ester, vinyl ester, allyl ester and butenyl ester groups and mixtures thereof.

5. The process as claimed in claim 4, wherein the copolymerizable, olefinically unsaturated groups of the polyurethane (a.1.2) are vinyl groups.

6. The process as claimed in claim 5, wherein the vinyl groups of the polyurethane (a.1.2) are contained in ethenylarylene groups.

7. The process as claimed in claim 6, wherein the polyurethane (a.1.2) is prepared by
(1) reacting at least one polyurethane prepolymer (a.1.2.1) containing at least one free isocyanate group with
(2) at least one adduct (a.1.2.2) obtained by reacting at least one ethenylarylene monoisocyanate and at least one compound containing at least two isocyanate-reactive functional groups
with one another such that at least one isocyanate-reactive functional group remains in the adduct (a.1.2.2).

8. The process as claimed in claim 7, wherein the isocyanate-reactive functional group is selected from the group consisting of hydroxyl groups, thiol groups, primary amino groups and secondary amino groups.

9. The process as claimed in claim 7, wherein the ethenylarylene monoisocyanate has the general formula I:
CH₂—C(R)-A-X—NCO (I)
in which the definition of the variables is as follows:
A=substituted or unsubstituted C₆-C₂₀ arylene radical;
R=hydrogen atom, halogen atom, nitrile group or a substituted or unsubstituted alkyl, cycloalkyl, alkylcycloalkyl, cycloalkylalkyl, aryl, alkylaryl, cycloalkylaryl, arylalkyl or arylcycloalkyl radical; and
X=divalent organic radical.

10. The process as claimed in claim 9, wherein the arylene radical A is 1,2-, 1,3- and/or 1,4-phenylene.

11. The process as claimed in claim 1, wherein the polyurethane (a.1.2) contains hydrophilic functional groups, selected from the group consisting of carboxylic acid groups and carboxylate groups and mixtures thereof.

12. The process as claimed in claim 1, wherein the pigment (a.2) is selected from the group consisting of organic color pigments, inorganic color pigments, optical effect pigments, color and optical effect pigments, magnetically shielding pigments, electrically conductive pigments, anticorrosion pigments, fluorescent pigments, and phosphorescent pigments and mixtures thereof.

13. The process as claimed in claim 1, wherein the UV-absorbing pigment (a.3) is selected from the group consisting of titanium dioxide pigments and carbon black pigments.

14. The process as claimed in claim 13, wherein the coating material (A) comprises a titanium dioxide pigment (a.3) and a carbon black pigment (a.3).

15. The process as claimed in claim 1, wherein the coating material (A) comprises at least one additive (a 5).

16. The process as claimed in claim 15, wherein the additive (a.5) is selected from the group consisting of crosslinking agents, oligomeric binders and polymeric binders other than the (co)polymers and graft copolymers (a.1), pigments selected from the group consisting of organic, inorganic chromatic, achromatic, transparent and opaque pigments, fillers, nanoparticles other than the pigments (a.2) to (a.4), organic solvents, driers, antisettling agents, UV absorbers, light stabilizers, free-radical scavengers, devolatilizers, slip additives, polymerization inhibitors, defoamers, emulsifiers, wetting agents, adhesion promoters, leveling agents, film-forming auxiliaries, rheology control additives, and flame retardants, and mixtures thereof.

17. The process as claimed in claim 1, wherein the coating materials (A) and (B) are applied with a wet film thickness such that, after curing, a dry film thickness (A+B) totaling from 10 to 25 μm results.

18. The process as claimed in claim 1, wherein the coating material (A) is applied in a wet film thickness such that, after curing, a dry film thickness of from 8 to 12 μm results.

19. The process as claimed in claim 1, wherein the coating material (B) is applied with a wet film thickness such that, after curing, a dry film thickness of from 6 to 10 μm results.

20. The process as claimed in claim 1, wherein the coating is applied to substrates selected from the group consisting of bodies of means of transport and parts thereof, buildings and parts thereof, doors, windows, furniture, small industrial parts, mechanical, optical, and electronic components, coils, containers, packaging, hollow glassware, and articles of everyday use.
